(19) United States
(12) Patent Application Publication
(10) Pub. No.: US 2016/0126853 A1
(43) Pub. Date: May 5, 2016

(54) Partial Time Active Clamp Flyback

(71) Applicant: Marco Antonio Davila, Tucson, AZ (US)

(72) Inventor: Marco Antonio Davila, Tucson, AZ (US)

(73) Assignee: ROMPOWER ENERGY SYSTEMS, INC., Tucson, AZ (US)

(21) Appl. No.: 14/933,476

(22) Filed: Nov. 5, 2015

Related U.S. Application Data
(60) Provisional application No. 62/075,518, filed on Nov. 5, 2014.

(51) Int. Cl. H02M 3/335

(52) U.S. Cl. CPC H02M 3/33592

(57) ABSTRACT

A method is shown to improve the resonant transition controlled flyback converter presented in Ser. No. 14/274,598 (Exhibit A) by adding a clamp circuit that recycles the leakage energy. By utilizing the particular advantages of the resonant transition controlled flyback converter an optimized clamp capacitor can be used to increase the efficiency of the converter further.

### RELATED APPLICATION/CLAIM OF PRIORITY

This application is related to and claims priority from U.S. provisional application Ser. No. 62/075,518, filed Nov. 5, 2014, and which provisional application is incorporated by reference herein.

### INTRODUCTION AND SUMMARY OF THE PRESENT INVENTION

The Flyback converter is the most popular converter for off line applications. Applications include AC to DC adapters for laptops, tablets, cellular phones, and many other portable devices. Key to the Flyback topology's popularity is a simple design offering a wide operating range compared to other topologies. Also, in discontinuous mode the Flyback converter has discrete energy packets leading to higher efficiency at low output power. High efficiency at low output power is vitally important because the adapter is used for charging mobile devices and the majority of the users will leave an adapter plugged in requiring the adapter to be in standby or low power output mode. It has been statically proven that the standby power called vampire power causes more losses than the inefficiency of the unit while charging the mobile device.

In today's modern world of green efficiency and ever reduction in size of mobile devices the Flyback's ability to reduce standby power is not enough. Green initiatives require adapters to have higher efficiencies in all power modes. Another, possibly stronger, pressure for increased efficiency is reduction in size for cost and portability. When the adapter's size is reduced its ability to dissipate heat is also reduced. Not increasing the adapter's efficiency would lead to uncomfortable even dangerous operating temperatures. Decreasing the size of the adapter demands the efficiency of popular Flyback converter be increased in all power modes.

Several methods for increasing a Flyback's efficiency are in use today. Two methods in common use are synchronous rectification of the secondary and using the Flyback's ability to resonate to provide near zero or zero volt switching (ZVS). Synchronous rectification in the secondary decreases the loss associated with a diode rectifier. The resonant ZVS decreases the power needed to switch the MOSFETS at the cost of increased complexity of finding the valley point in the resonant waveform. Turning on the first ring is called boundary mode and turning on after the first ring is called discontinuous mode. The method to move the ring to a desired location by shorting the winding has been presented in patent application Ser. No. 14/274,598, which is incorporated by reference (and a copy of that application is Exhibit A hereto). The present invention presented in this application addresses another source of power loss/savings. This method of this invention involves recycling the leakage energy and steering the primary and secondary current to improve the efficiency. This invention is independent of the shorting winding invention presented in the previous patent application but can be very useful when combined with the invention of that application.

As seen from the following description, the present invention provides an inductive power supply circuit with a transformer, a primary and a secondary in which there is leakage energy in the transformer, with a method of improving efficiency that comprises storing the leakage energy in the primary and recycling the stored energy to the secondary during the reset period of the transformer. The method preferably provides an active clamp circuit portion that is turned on during the reset period of the transformer, and causes the leakage energy to be transferred to the secondary and portion of it to be stored in the transformer, returning back to the primary at the end of the dead time period decreasing the voltage across the primary switch towards zero. Moreover, the method preferably also includes providing the inductive power supply circuit with a shorting circuit portion, and configuring the power supply circuit to share voltage between the shorting circuit portion and the active clamp portion and reduces the voltage rating of the clamp switch.

In addition, the present invention provides in an inductive power supply circuit with a transformer, a synchronous rectifier, a primary and a secondary, in which there is leakage energy in the transformer, a method of improving efficiency by providing an active clamp circuit that shuts off in predetermined timing relation to the synchronous rectifier, to produce different residual currents to reduce the turn on voltage across the main switch, while reducing the voltage stress on the main switch.

Still further, the present invention provides a method of controlling the natural ring of an inductive circuit that includes a primary and a secondary, comprising
a. providing an inductive circuit with a choke that stores and releases energy, a switch having a closed state in which it causes the choke to store energy and another switch having a closed state in which it causes the choke to release energy, the inductive circuit configured with parasitic capacitance that would normally produce natural ringing when energy in the choke has been substantially released,
b. shorting the choke to trap and hold current and pause the natural ringing until power is directed to the inductive circuit to release shorting of the choke prior to initiating storage of energy in the choke, and
c. recycling leakage energy and shaping the current in the primary and secondary to improve the efficiency.

Additionally, the present invention provides a method of controlling the natural ring of an inductive circuit that includes a primary and a secondary, comprising
a. providing an inductive circuit with a transformer that stores and releases energy, a switch having a closed state in which it causes the transformer to store energy and another switch having a closed state in which it causes the transformer to release energy, the inductive circuit configured with parasitic capacitance that would normally produce natural ringing when energy in the transformer has been substantially released,
b. shorting the transformer during a reset period of the transformer to trap and hold current and pause the natural ringing until power is directed to the inductive circuit to release shorting of the transformer prior to initiating storage of energy in the transformer, and
c. storing leakage energy in the primary and recycling the stored energy to the secondary during the reset period of the transformer.

Other features of the present invention will be clear from the following detailed description and the accompanying drawings.

### BRIEF DESCRIPTION OF THE DRAWINGS

FIG. 1 shows a simplified Flyback circuit and its associated voltage waveform of the drain voltage of main primary switch;

FIG. 2 shows a circuit equivalent to FIG. 1 with a typical clamp circuit;

FIG. 3 shows that if the active clamp is turned on only during the reset of transformer and not the full off period, the energy that is bounced back to the winding causes larger ringing during the discontinuous time;

FIG. 4 shows a circuit that combines the circuit of exhibit A combined with the active clamp turned on only during the reset of transformer and not the full off period, so that the energy that is bounced back to the winding causes larger ringing during the discontinuous time;

FIG. 5 shows the current and voltage waveforms for the circuit of FIG. 4;

FIG. 6 shows a comparison between secondary currents with a conventional clamp and secondary currents with different capacitance values for the active clamp;

FIG. 7 shows a particular implementation of the clamp circuit combined with the shorting MOSFET circuit in a way that a low voltage rating P channel MOSFET can be used; and

FIG. 8 shows timing waveforms for the circuit of FIG. 7.

### DETAILED DESCRIPTION

### 2. Active Clamp to Recycle Leakage Energy

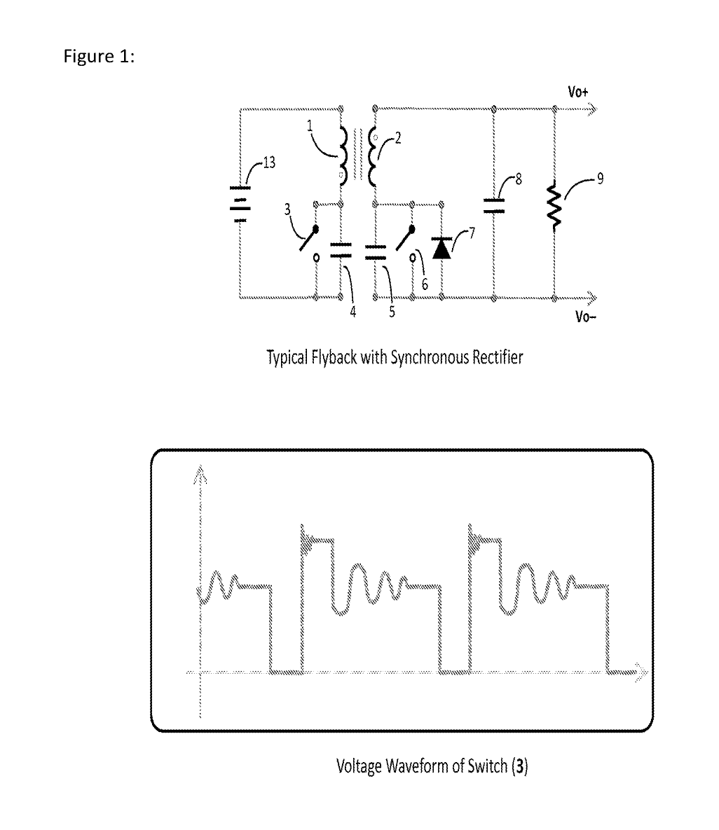

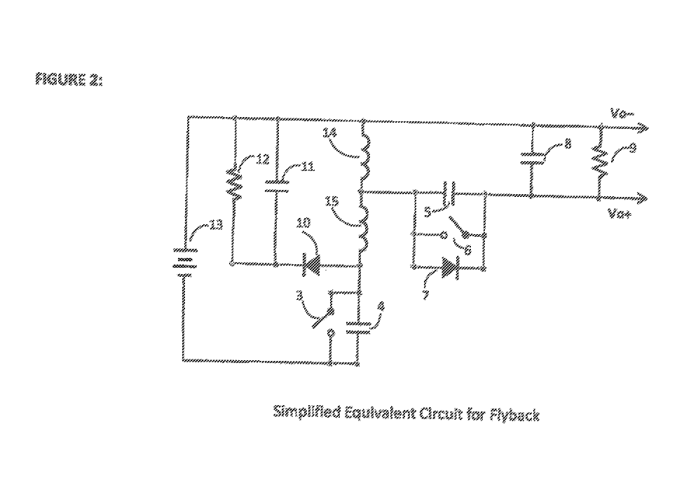

Presented in FIG. 1 shows a simplified Flyback circuit and its associated voltage waveform of the drain voltage of main primary switch (3). The voltage stress when the switch turns off is the sum of the input voltage, the reflected output voltage, and a leakage inductance spike. The reason there is a spike is that it takes extra voltage to transfer the current flowing in the primary to the secondary. This is caused by the leakage inductance of the transformer. It is part of the inductance of the transformer that is not coupled to the secondary. All transformers consist of two basic modeled components. One is the leakage inductance (15) the other is the mutual inductance (14). The mutual inductance is the component that allows current to move between primary and secondary while the leakage inductance resists the movement. The equivalent circuit is shown in FIG. 2 with a typical clamp circuit.

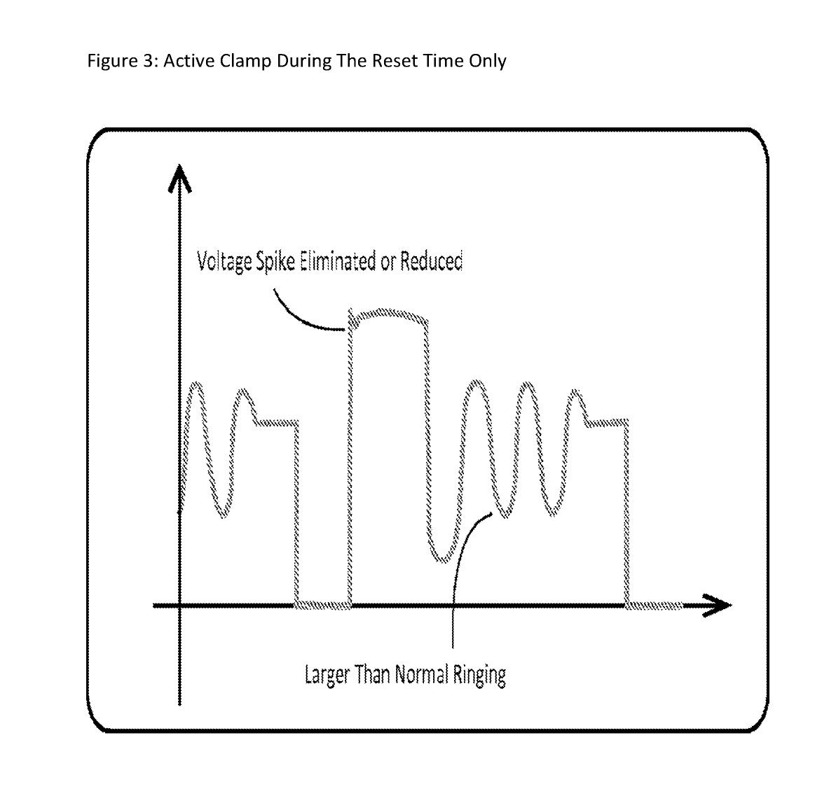

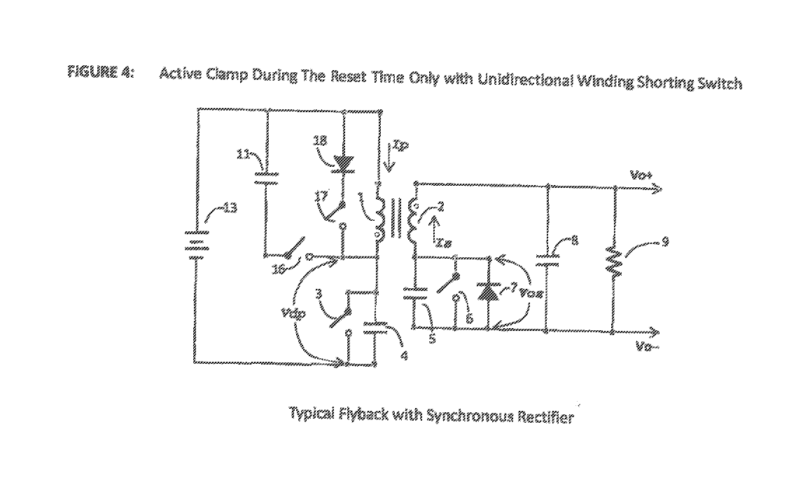

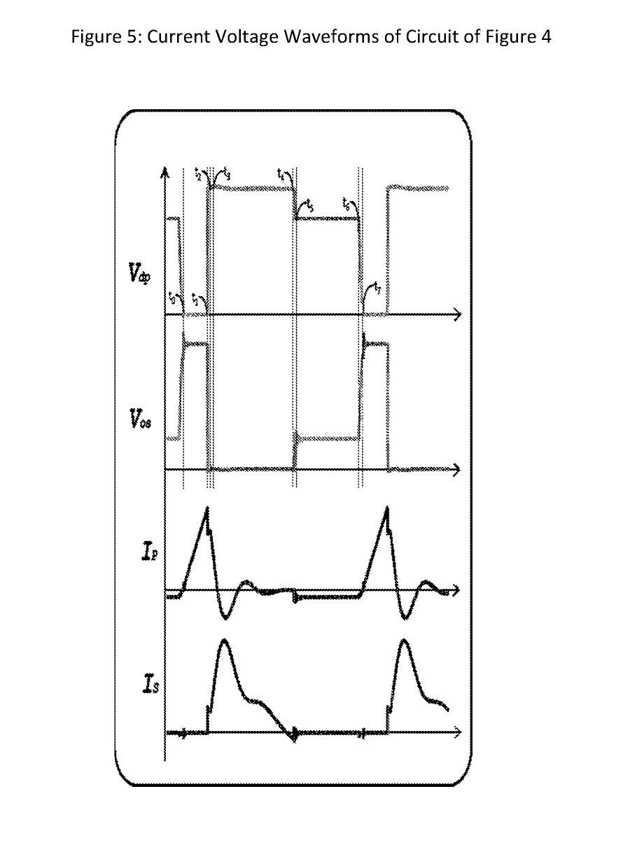

To deal with the voltage spike a clamp circuit, formed by 10, 11 and 12, is employed that absorbs the energy in the leakage inductance transferring it to a capacitor and then finally dissipating it in a resistor. Therefore, the energy stored in the leakage inductance of the transformer is lost. Because the same peak primary current in a flyback flows in both the leakage inductance and mutual inductance, the energy in each inductor is proportional by the inductance value. The ratio of the two energies is the ratio of the leakage inductance to the mutual inductance. This means that if a Flyback converter is producing 100 watts on the output and if the leakage inductance is 1% of the mutual inductance 1 watt is dissipated in a typical clamp. With converters approaching efficiencies of 95%, 1% power loss is a large portion. If this energy were to be saved, the efficiency of the converter would improve by 1%. One method of energy recovery is to store it in a capacitor like a normal clamp but instead of dissipating it, if the energy were to be transferred back to the winding this energy would be saved. Unfortunately, this is not as simple as it first seems. If too small of a capacitor is used there would be ringing between the clamp capacitor, the leakage in the circuit, and the parasitic capacitance of the flyback converter. The energy would just bounce back and forth dissipating in any resistance between them and will not transfer completely to the secondary. The capacitor chosen has to be large enough that half the ringing period is at least the reset time to reduce energy flow back and forth. If done correctly the energy would be transferred completely to the secondary and not allowed to return back. A switch is needed that controls the current into and out of the capacitor so that at the point that the reset is finished the capacitor would hold its voltage until the next reset. Normal active clamps use all of the off time to store and release the leakage inductance energy. But if the active clamp is turned on only during the reset of transformer and not the full off period, the energy that is bounced back to the winding causes larger ringing during the discontinuous time as shown in FIG. 3. If this is combined with Ser. No. 14/274,598 (Exhibit A) this extra energy can be used to add on to the energy needed to soft switch the converter or at least help to lower the voltage where the primary switch turns on. Shown in FIG. 4 is this circuit that employs these combined ideas. The current and voltage waveforms are shown in FIG. 5.

Starting at time T0, the main primary switch (3) is on and all other switches are off.

Current ramps up in the primary winding (1) of the transformer from 0 amps to the programed peak current at time T1. At time T1, the main switch turns off but the current continues to flow into the main switches and the transformer's parasitic capacitances shown as single capacitance (4). There is also secondary parasitic capacitance of the transformer and the output switch. This is also modeled as a single capacitance (5). As the voltage across the primary increases the voltage in the secondary decreases. Depending on the amount of leakage inductance and the values of the primary and secondary parasitic capacitances a small portion of the primary current is steered to the secondary during the time drain voltage is increasing to discharge the secondary capacitance. At time T2, the voltage on the main switch reaches a value large enough to forward bias the body diode of the clamp switch (16). At this point most of the primary current diverts from charging the parasitic capacitance of the main switch and primary winding to charging the clamp capacitor since the capacitance of the clamp is larger than the parasitic capacitance of the rest of circuit. The secondary current that diverted during the drain voltage increase continues to discharge the output parasitic capacitance until the body diode (7) of the secondary switch turns on. This occurs slightly after the primary current is diverted in the clamp. If the capacitor in the clamp is a large enough value, the capacitor (11) at the start of time T2 has a slightly larger voltage than the reflective output voltage. This slight voltage difference ramps down the current in the primary and ramps up the current in the secondary. Because charge has to balance in the clamp capacitor in steady state, the extra voltage that appears on the capacitor is exactly the voltage needed to steer the current so that integral of current over time is zero. If too much charge comes in, the voltage in the capacitor will increase and on the next cycle less would come in due to the larger voltage. If the capacitor is smaller, its voltage changes during the reset period but the average voltage is equal to voltage that an equivalent larger capacitor would have. There are some advantages in choosing the right capacitor value. If a small capacitance is chosen then at time T2 the voltage where the current is diverted from charging the main switch to charging the capacitor occurs earlier. This creates a softer or rounded voltage waveform. In either case, at T3 the clamp switch is turned on with a slight delay from T2 so that the drop across the clamp diode is reduced. The current into the clamp continues to ramp down until it crosses zero. At that point all the primary current that was stored in the transformer has been diverted to the secondary. Since the capacitor must balance the charge, the current continues to ramp down and become negative. This means that the clamp starts to deliver current and this current is transferred to the secondary. The current in the secondary is now the addition of the normal magnetizing current plus the increasing current from the clamp. The energy that was originally stored in the leakage then transferred to the clamp capacitor is now being sent to the secondary. There are different current shapes that can be tailored from the clamp depending on the value of capacitance, the amount of leakage inductance, and the reset time. The capacitance has to be large enough that when the reset cycle finishes there is still some current flowing from the clamp to the secondary. When the magnetizing current contribution reaches zero the leakage inductance stills contains some energy from the current of the clamp. If the converter runs with extra push back current then the clamp and secondary is allowed to stay on longer past this point. It does not matter if the energy of the clamp or the energy of the secondary is used for push back current since the clamp delivered most of its energy to the secondary during most of the reset time. Now the energy in the transformer is the combination of the leakage energy and the magnetizing energy. It was found out it is slightly more efficient to keep the clamp on longer than the secondary switch so that it provides the push back. This makes sense since the current needed for soft switching is being used to discharge mostly the parasitic capacitance of the primary switch. If more energy is used from the clamp the system will rebalance the clamp due to the charge balance mentioned before. At T4, both the clamp switch and the secondary synchronous rectifier are off. The current flowing into the primary winding (1) discharge the parasitic capacitance (4) of the primary switch, primary winding. It also charges the parasitic capacitance (5) of the secondary switch and secondary winding. At T5, the shorting MOSFET (17) is activated shorting the winding keeping the primary voltage at line voltage. The current in the transformer circulates through the shorting MOSFET conserving the stored energy in the magnetizing and leakage inductance. At time T6 the shorting MOSFET turns off. The sequence between T5 to T6 gives the converter the ability to lower the frequency of the converter to control power by increasing the time between T5 and T6. When the shorting switch turns off at T6 the energy in both the leakage inductance and mutual inductance are allowed to continue to discharge the parasitic capacitances of the primary MOSFET and the primary winding while charging the parasitic capacitance of the secondary synchronous rectifier and secondary winding. The amount of energy was controlled by the timing of T4 when the clamp and synchronous rectifier were turned off. This energy is now used at T6 to control how much to discharge the parasitic capacitances. When this energy is exhausted at T7, the primary switch is turned on at a lower than normal voltage thus reducing turn on losses. The sequence now repeats since T7 is the same T0.

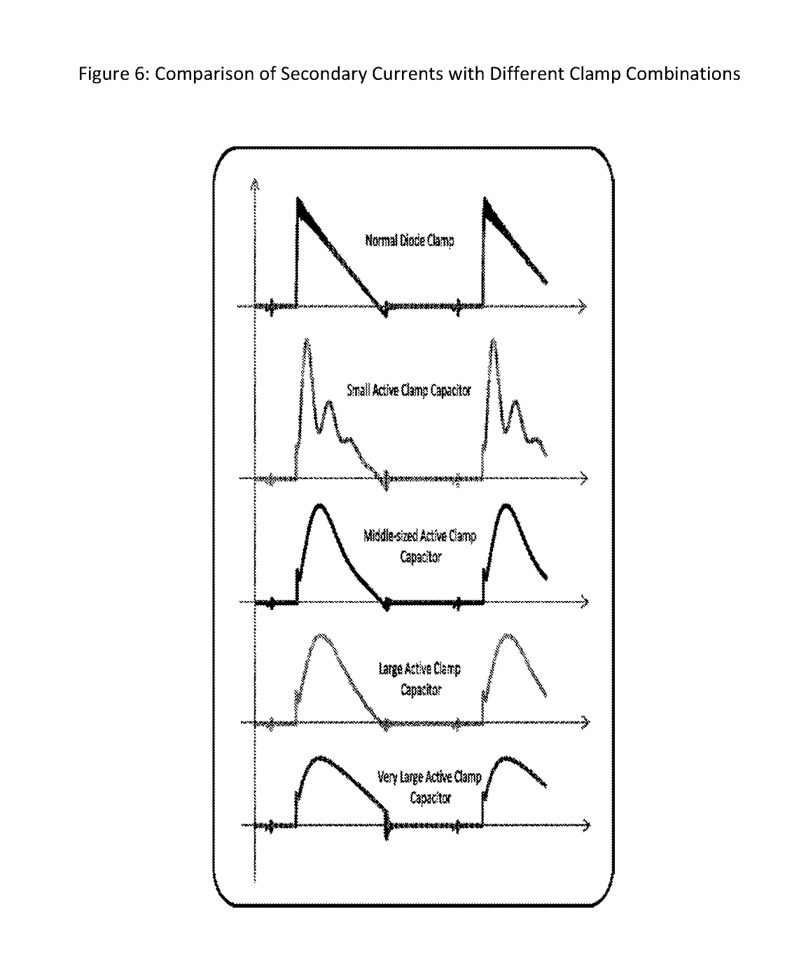

Not only is the energy in the leakage inductance recycled, it is used to help to reduce the turn on losses of the main switch. There are three more benefits to this active clamp circuit. The clamp slows the transition of the current between the primary and secondary. At first sight this does not seem to be an advantage but there are three benefits from it. First, the frequency content of the current waveform in the primary is reduced since the transition times are slower this reduces proximity and skin effect losses in the winding because the amount of losses are dependent on the frequency content of the waveform. Second benefit has to do with timing. Since the current in the synchronous rectifier in the secondary ramps more slowly, there is less dissipation in the rectifier due to turn on timing mismatch. The reduction in dissipation in the rectifier due to turn on mismatch is due to the reduction in the power dissipation through the body diode. The synchronous rectifier turn on can be delayed without affecting dissipation tremendously. In a converter with a conventional clamp the timing is more critical and cannot be perfect so it is a source of dissipation. The third benefit is there is a reduction of root mean square current in the secondary. The normal current waveform in the secondary is a saw tooth triangular waveform. By adding the clamp a portion of the current is delayed to the middle of the waveform. Thus the peak current is reduced which reduces the RMS current of the secondary. See FIG. 6 for the comparison between secondary currents with a conventional clamp and secondary currents with different capacitance values for the active clamp.

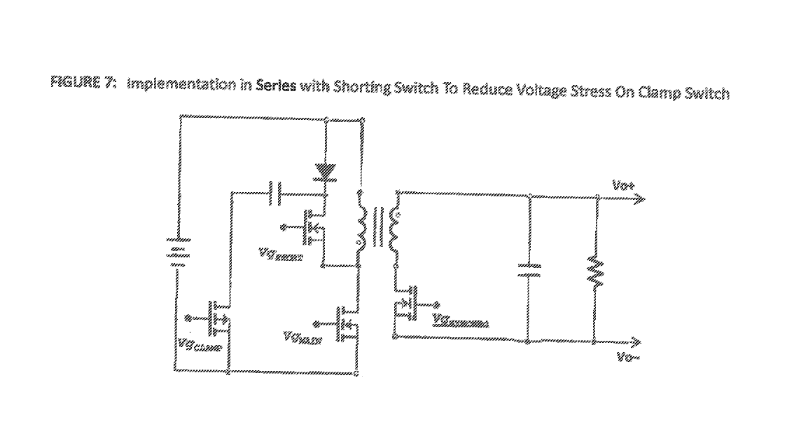

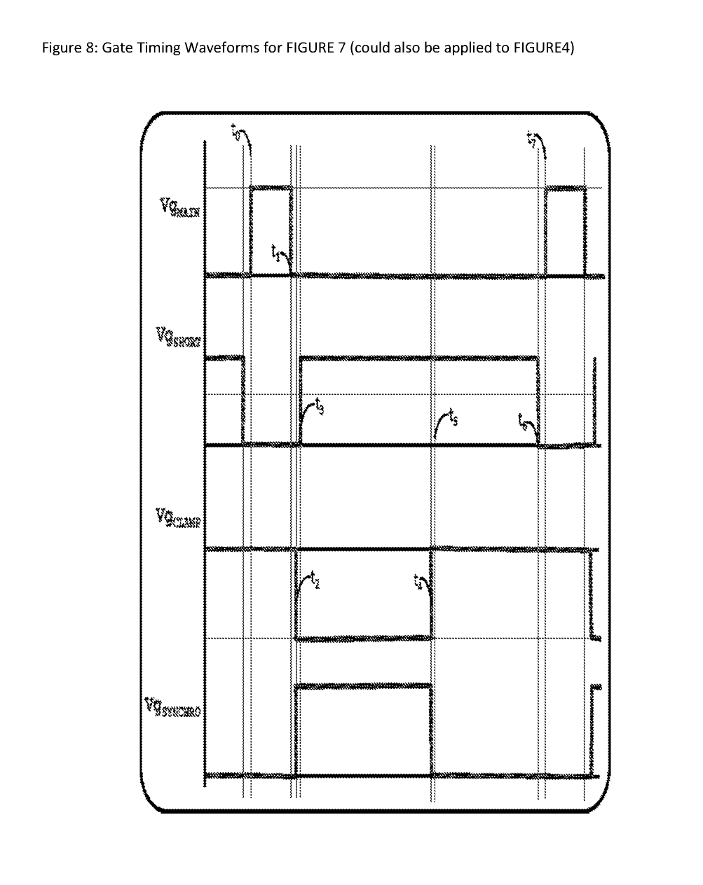

Shown in FIG. 7 is a particular implementation of the clamp circuit combined with the shorting MOSFET circuit in a way that a low voltage rating P channel MOSFET can be used. In this circuit the clamp MOSFET controls the voltage only during the times the transformer is resetting. The shorting MOSFET is turned on at the same time as the clamp MOSFET. The stress on the P channel is the reflected secondary voltage only. The clamp capacitor has the voltage stress of both the line voltage plus the reflected secondary voltage. When the primary switch is on, the shorting MOSFET has the input voltage as stress while the clamp MOSFET has the reflected voltage. The diode in series with shorting MOSFET insures that the shorting MOSFET voltage stress is clamped to line voltage and also is used in the circuit to control the shorting direction when the shorting MOSFET activates. In this circuit the voltage stresses of the input line and reflected voltages are shared between the shorting MOSFET and the clamp MOSFET while the clamp capacitor has a larger voltage stress. In most situations this is more economical than having a higher voltage rated clamp MOSFET. Timing waveforms are shown in FIG. 8.

From FIG. 6, it can be seen that some capacitance values produce lower RMS current waveforms while keeping the primary voltage waveform without spikes. The reset times in a flyback converter do vary somewhat but this variation is minimized when the peak current and frequency are both controlled. With this in mind, the clamp capacitor value that produces the most efficient waveforms can be chosen.

The following information is believed useful to appreciate the timing concepts of a convention flyback, the flyback of Exhibit A, and a flyback according to the principles of the present invention, as will be readily understood by those in the art from this application.

Initially, in a flyback converter, dead time, resonant time and rest period are different times, as will be appreciated by those in the art.

In a conventional flyback converter, the time sequence is as follows:
1. The transformer is energized by the primary (considered to be on time)
2. Energy in the transformer is released to the secondary until the transformer runs out of energy (considered to be reset time)
3. The transformer sits with no energy and waits for the next on time (called dead time). During this time the transformer rings since all switches are off or open. So you could argue that it is also the resonant transition time but the ringing does not stop.

For the flyback of application Ser. No. 14/274,598 (Exhibit A):
1. The transformer is energized by the primary
2. The transformer is reset but kept in reset a little longer by keeping the output switch on longer to accumulate energy in reverse direction somewhat (push back)
3. The transformer sits with a little extra energy but is not allowed to ring since it is shorted by a third switch (or switch network)
4. The short is released and the transformer is allowed to ring down once (portion of a full ring) then transformer is reenergized (back to #1). This is what applicant calls the resonant transition time.
5. Thus, once can see that applicant has somewhat changed the reset very little but changed the dead time portion a lot.

For a flyback with clamp and transition, according to the principles of the present invention, the sequence is:
1. The transformer is energized by the primary
2. The transformer is reset, but the clamp is also turned on during this time, energy of the leakage and reset are mixed together and sent to output. Reset is kept on a little longer by clamp, output switch, or both.
3. The transformer sits with a little extra energy (from extra on time as before) but is not allowed to ring since it is shorted by a third switch (or switch network)
4. The short is released and transformer is allowed to ring down once (portion of a full ring) then transformer is reenergized (back to #1). This is what we call the resonant transition time.

So the principal difference with the clamp concept of Ser. No. 14/274,598 (Exhibit A) is that the energy of the leakage inductance is added to the reset energy of the transformer and we have a choice of which of the switches (clamp or output switch or both) to turn off last.

Thus, as seen from the forgoing description, the present invention provides an inductive power supply circuit with a transformer, a primary and a secondary in which there is leakage energy in the transformer, with a method of improving efficiency that comprises storing the leakage energy in the primary and recycling the stored energy to the secondary during the reset period of the transformer. The method preferably provides an active clamp circuit portion that is turned on during the reset period of the transformer, and causes the leakage energy to be transferred to the secondary and portion of it to be stored in the transformer, returning back to the primary at the end of the dead time period decreasing the voltage across the primary switch towards zero. Moreover, the method preferably also includes providing the inductive power supply circuit with a shorting circuit portion, and configuring the power supply circuit to share voltage between the shorting circuit portion and the active clamp portion and reduces the voltage rating of the clamp switch.

In addition, the present invention provides in an inductive power supply circuit with a transformer, a synchronous rectifier, a primary and a secondary, in which there is leakage energy in the transformer, a method of improving efficiency by providing an active clamp circuit that shuts off in predetermined timing relation to the synchronous rectifier, to produce different residual currents to reduce the turn on voltage across the main switch, while reducing the voltage stress on the main switch.

Still further, the present invention provides a method of controlling the natural ring of an inductive circuit that includes a primary and a secondary, comprising
a. providing an inductive circuit with a choke that stores and releases energy, a switch having a closed state in which it causes the choke to store energy and another switch having a closed state in which it causes the choke to release energy, the inductive circuit configured with parasitic capacitance that would normally produce natural ringing when energy in the choke has been substantially released,
b. shorting the choke to trap and hold current and pause the natural ringing until power is directed to the inductive circuit to release shorting of the choke prior to initiating storage of energy in the choke, and
c. recycling leakage energy and shaping the current in the primary and secondary to improve the efficiency.

Additionally, the present invention provides a method of controlling the natural ring of an inductive circuit that includes a primary and a secondary, comprising
a. providing an inductive circuit with a transformer that stores and releases energy, a switch having a closed state in which it causes the transformer to store energy and another switch having a closed state in which it causes the transformer to release energy, the inductive circuit configured with parasitic capacitance that would normally produce natural ringing when energy in the transformer has been substantially released,
b. shorting the transformer during a reset period of the transformer to trap and hold current and pause the natural ringing until power is directed to the inductive circuit to release shorting of the transformer prior to initiating storage of energy in the transformer, and
c. storing leakage energy in the primary and recycling the stored energy to the secondary during the reset period of the transformer.

To summarize, the benefits of this invention are reduction of voltage spike on the primary due to leakage inductance, reduction of the RMS current in the secondary winding and synchronous rectifier, reduction in high frequency content of both primary and secondary current, less constraint on the synchronize rectifier turn on timing, recycling of the leakage energy, and reuse of the leakage energy for near zero volt switching.

1. In an inductive power supply circuit with a transformer, a primary and a secondary in which there is leakage energy in the transformer a method of improving efficiency that comprises storing the leakage energy in the primary and recycling the stored energy to the secondary during the reset period of the transformer.

2. In the inductive power supply circuit of claim 1, wherein the method provides an active clamp circuit portion that is turned on during the reset period of the transformer, and causes the leakage energy to be transferred to the secondary and portion of it to be stored in the transformer, returning back to the primary at the end of the dead time period decreasing the voltage across the primary switch towards zero.

3. In the inductive power supply circuit of claim 2, wherein the method includes providing the inductive power supply circuit with a shorting circuit portion, and configuring the power supply circuit to share voltage between the shorting circuit portion and the active clamp portion and reduces the voltage rating of the clamp switch.

4. In an inductive power supply circuit with a transformer, a synchronous rectifier, a primary and a secondary, in which there is leakage energy in the transformer, a method of improving efficiency by providing an active clamp circuit that shuts off in predetermined timing relation to the synchronous rectifier, to produce different residual currents to reduce the turn on voltage across the main switch, while reducing the voltage stress on the main switch.

5. A method of controlling the natural ring of an inductive circuit that includes a primary and a secondary, comprising
a. providing an inductive circuit with a choke that stores and releases energy, a switch having a closed state in which it causes the choke to store energy and another switch having a closed state in which it causes the choke to release energy, the inductive circuit configured with parasitic capacitance that would normally produce natural ringing when energy in the choke has been substantially released,
b. shorting the choke to trap and hold current and pause the natural ringing until power is directed to the inductive circuit to release shorting of the choke prior to initiating storage of energy in the choke, and
c. recycling leakage energy and shaping the current in the primary and secondary to improve the efficiency.

6. A method of controlling the natural ring of an inductive circuit that includes a primary and a secondary, comprising
a. providing an inductive circuit with a transformer that stores and releases energy, a switch having a closed state in which it causes the transformer to store energy and another switch having a closed state in which it causes the transformer to release energy, the inductive circuit configured with parasitic capacitance that would normally produce natural ringing when energy in the transformer has been substantially released,
b. shorting the transformer during a reset period of the transformer to trap and hold current and pause the natural ringing until power is directed to the inductive circuit to release shorting of the transformer prior to initiating storage of energy in the transformer, and
c. storing leakage energy in the primary and recycling the stored energy to the secondary during the reset period of the transformer.
